(19) United States
(12) Patent Application Publication
(10) Pub. No.: US 2008/0097789 A1
(43) Pub. Date: Apr. 24, 2008

(54) Quality Management Of Patient Data For Health Care Providers

(76) Inventor: Robert L. Huffer, Orlando, FL (US)

Correspondence Address: Ferdinand M. Romano, Esquire;Beusse Wolter Sanks Mora & Maire, P.A., Suite 2500, 390 North Orange Avenue, Orlando, FL, 32801, US

(21) Appl. No.: 11/769,110

(22) Filed: Jun. 27, 2007

Related U.S. Application Data
(60) Provisional application No. 60/862,704, filed on Oct. 24, 2006.

(51) Int. Cl. G06Q 10/00

(52) U.S. Cl. 705/2

(57) ABSTRACT

A system and a method of identifying a need to modify data entries in a database containing healthcare admissions data. An exemplary data quality management system is useful for managing healthcare admissions data. According to an embodiment the system can include a first computer system comprising at least one server and having storage media. The media may contain a plurality of sets of patient data each assembled by a different health care provider and useful in relation to filing of insurance claims. A plurality of rules engines may each be customized for a different health care provider with each stored in human readable code. A program, which when run on the first computer system, compiles a first of the rules engines customized for a first of the health care providers wherein rules associated with the first rules engine are applied to identify needs for modifying a set of patient data received from the first health care provider.

### RELATED APPLICATION

This application claims priority to U.S. 60/862,704 filed Oct. 24, 2006, which is incorporated herein by reference in its entirety.

### BACKGROUND OF THE INVENTION

The invention pertains to analysis of healthcare data files and, more particularly, to processing of patient data for quality assurance purposes. It is estimated that hospitals lose four to five percent of expected net revenues in the claims process. As many as 40 percent of the 15 billion claims processed annually are rejected or denied at least once during the administrative process. In many instances, causal errors are not corrected for resubmittals.

With health care spending exceeding $500 billion, based on conservative assumptions it has been estimated that hospitals alone, in the U.S., are losing over $25 billion per year in collections. For the average 250-bed hospital these revenue losses may be on the order of $4.5 million each year. In any industry with average margins of four percent, elimination of such losses could increase the bottom line by fifty percent, and for many hospitals this can mean the difference between a net profit and a net loss.

An overview of a typical healthcare revenue cycle is illustrated in FIG. 1, beginning with patient access, followed by case management, clinical documentation and charge capture. Subsequent medical record completion and coding, is followed by billing and collection.

In view of the high percentage of claim denials, it has become commonplace to staff management activities to address prevention or correction of problems leading to claim denials. However, it has been difficult to eliminate process-related causes of claim denials because, for most hospitals, the revenue cycle is not a single, centralized system. Typically, there are numerous discrete departmental activities each having separate processes with local performance and accountability standards.

Errors leading to claim denials often begin in the patient access stage where patient data is entered into a database. Procedures for patient scheduling and registration may vary among departments. Moreover, staff involved in the data generation process may not be sensitized to the impact which errors in data entry can have on the hospital's overall financial condition.

The financial impact of common admissions data entry errors includes, as a significant component, the cost of human resources assigned to address the rejections. Seventy five percent or more of the personnel in a typical hospital business office are dedicated to such rework. Nationally, in the US, it is estimated that as many as 25,000 full-time hospital and medical group employees are dedicated to addressing denied claims and related management tasks. On the other hand, about 90% of all denials are preventable.

### BRIEF SUMMARY OF THE INVENTION

Examples of the invention are illustrated wherein a need is identified to modify entries in a database containing healthcare admissions data. In these examples a first computer system is provided for performing analysis of patient data generated by a health care provider and stored in a second computer system under the control of the health care provider. The first system may repeatedly receive, from the second computer system, one or more editions of code for applying error-checking rules to at least a portion of the admissions data, the code being received at the first computer system in a first form. The second system may also receive information present in the health care admissions data for performing analysis thereon. Each time, after receiving a set of information present in the health care admissions data, the most recently received edition of the code is converted into executable code for applying the rules to evaluate the most recently received information.

In another aspect of the invention a data quality management system is useful for managing healthcare admissions data. According to an embodiment the system can include a first computer system comprising at least one server and having storage media. The media may contain a plurality of sets of patient data each assembled by a different health care provider and useful in relation to filing of insurance claims. A plurality of rules engines may each be customized for a different health care provider with each stored in human readable code. A program, which when run on the first computer system, compiles a first of the rules engines customized for a first of the health care providers wherein rules associated with the first rules engine are applied to identify needs for modifying a set of patient data received from the first health care provider.

In still another aspect of the invention, a computer system may include a data processor and memory and software for evaluating healthcare admissions data file quality. In one example, a system router may be configured to receive multiple files, each containing information extracted from healthcare provider patient data files stored in a database remote from the computer system. One or more database servers include storage for retaining each of the patient data files distinct from the other. Multiple versions of rules code may each be simultaneously stored in source code form on the one or more servers, and each version may be associated with a different provider file. When each version is compiled and executed by the data processor, the code evaluates information from the associated provider file relative to a set of pre-determined validation rules.

### BRIEF DESCRIPTION OF THE DRAWINGS

The invention will be more clearly understood from the following description wherein an embodiment is illustrated, by way of example only, with reference to the accompanying drawings, in which:

FIG. 1 illustrates a healthcare revenue cycle;

FIG. 2A illustrates an exemplary process for generating validation rules;

FIG. 2B illustrates an exemplary portion of an extract file specification for a process in accord with FIG. 2A;

FIG. 3A illustrates a “Rule Definition” interface screen;

FIG. 3B illustrates a “Parts Definition Screen”;

FIG. 4 illustrates components of multiple validation rules;

FIG. 5 is a partial list of rules applicable to a quality assurance system according to the invention;

FIG. 6 illustrates features of an exemplary quality assurance system according to the invention;

FIG. 7 illustrates an exemplary configuration for a quality assurance system in relation to multiple health care provider data systems;

FIG. 8 further illustrates features of a quality assurance system;

FIG. 9 provides a listing of field names and associated descriptions for use in the quality assurance system;

FIG. 10 provides a listing of operator names and associated descriptions for use in the quality assurance system;

FIG. 11 provides a listing of error status names and associated descriptions for use in the quality assurance system; and

FIGS. 12A and 12B illustrate exemplary script code for the rule “BH01-Behavioral plan filed on non behavioral service”.

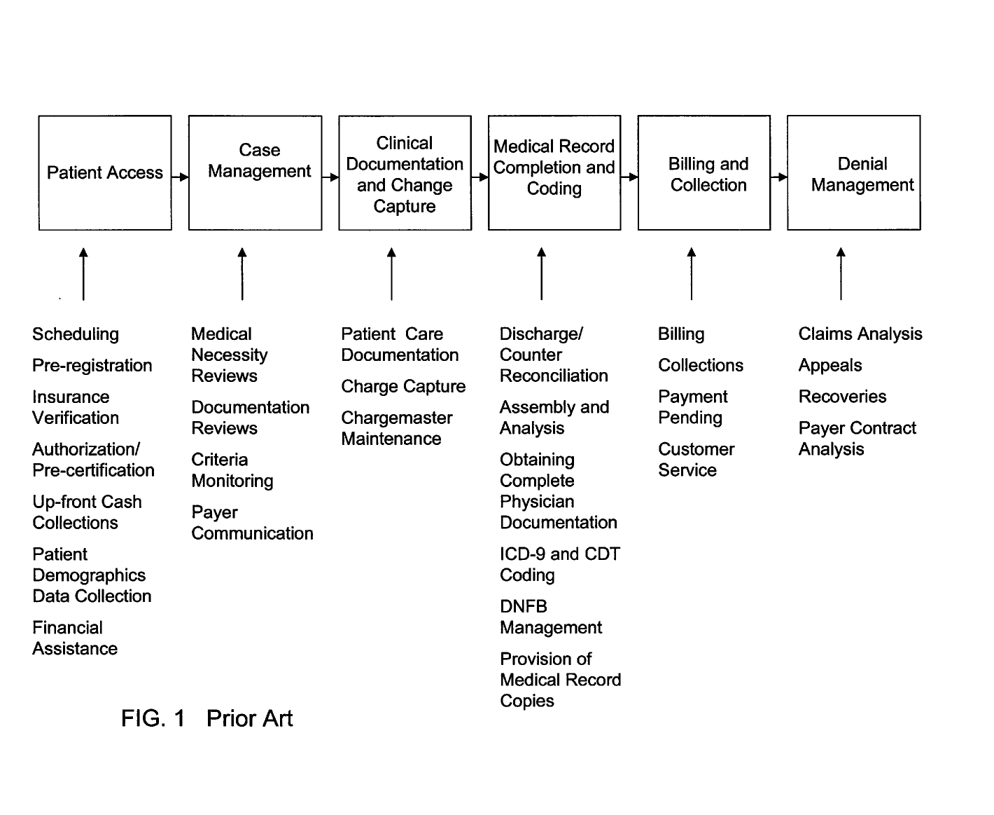

Like reference numbers are used throughout the figures to indicate like features. Individual features in the figures may not be drawn to scale.

### DETAILED DESCRIPTION OF THE INVENTION

There has been a need for a quality assurance (QA) system that systematically and comprehensively eliminates common patient-related errors or enables timely correction of such errors so as to reduce payor denials. In several embodiments of the invention, this entails monitoring of patient data for completeness, consistency or correct coding based on, for example, cross checking admissions data with clinical information. Further, customized analysis can be employed to improve the effectiveness of a monitoring effort, this having a beneficial effect on revenue integrity programs. Such a QA system can provide continual monitoring for data errors or deficiencies or claim rejections in order to expedite remedial efforts and thereby more quickly move the claims process to a successful completion.

Thus, in accordance with one embodiment of the invention, a QA system applies a dynamic rules engine 30 to process hospital admissions data. A data file specification defines fields of data in admissions records for analysis. The data is extracted from the admissions records and input to a processor-based subsystem of the QA system. Rules are developed for application to the extracted data. As more fully described herein, the extracted data may be ported from a hospital admissions data base to the processor-based subsystem which deploys the rules engine 30 to analyze the data. Other configurations are contemplated as well, wherein, for example, the rules engine may be run on a server-based system of a healthcare provider which contains the extracted data.

In the illustrated examples, rules of validation are used to test data strings extracted from one or more fields in the records of each patient. A feature of the invention is a user interface enabling, for example, staff at the healthcare provider's facility, to design the rules by selecting a combination of operators to evaluate information in strings of data or to compare information between strings of data. Exercising a rule as a combination of operations can result in a logical determination of consistencies or inconsistencies indicative of whether there is an absence or a presence of an error in the data associated with a field. This may merely involve comparisons of data in one field with expected values. In other implementations, the rule may be implemented by applying one or more conditional tests among one or multiple fields of data. Based on a combination of specific operations selected to analyze data, code can be generated to effect an automated process in which the data is analyzed, e.g., by logical determinations, for possible errors and omissions. The code may be stored in a relational database to programmatically represent the rule.

Once data fields to be evaluated are selected and validation rules are created, admissions data associated with the selected fields can be extracted from the provider's database and tested for compliance with the rules. In one embodiment of the invention, programming language classes are dynamically created based on the stored data file specification and compiled into binary data link libraries (DLLs) at the time of processing. Validation rules code may be read from the database and compiled at runtime into binary DLLs utilizing a specified set of interface methods called by the processing code. Admissions records are read into memory and validation rules code operates on each record to determine if there are any errors or omissions in the fields. A report can be generated each time the fields are evaluated so that data input personnel can rectify errors or omissions.

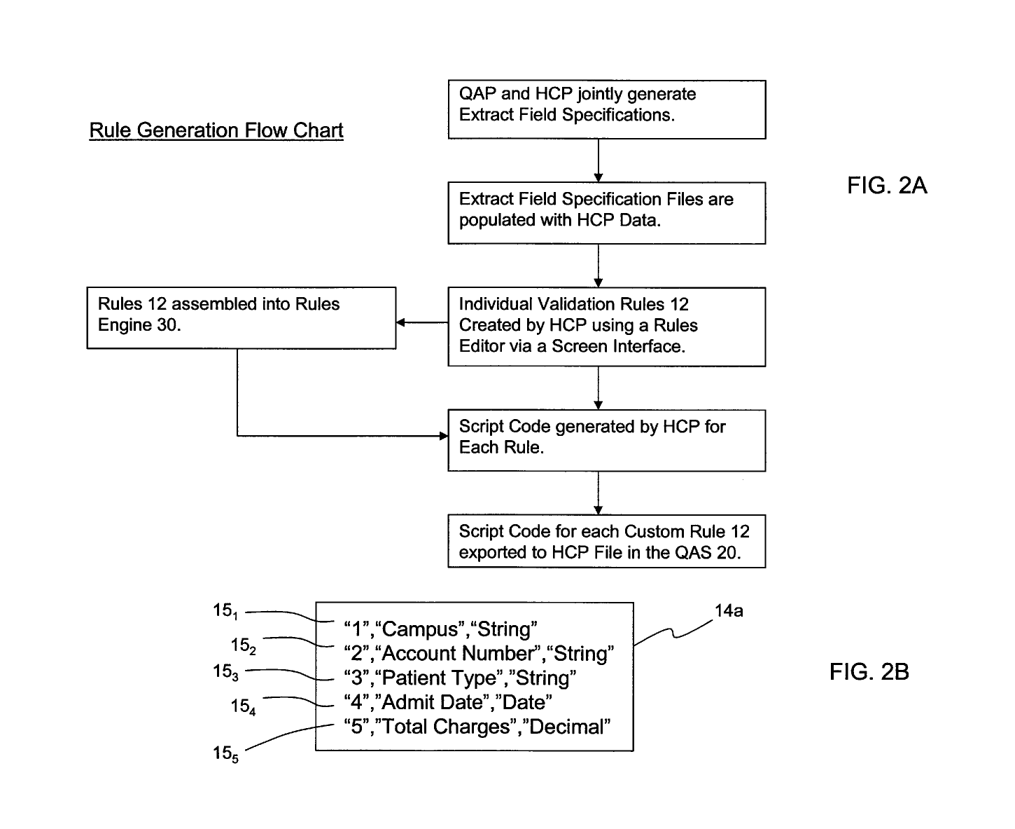

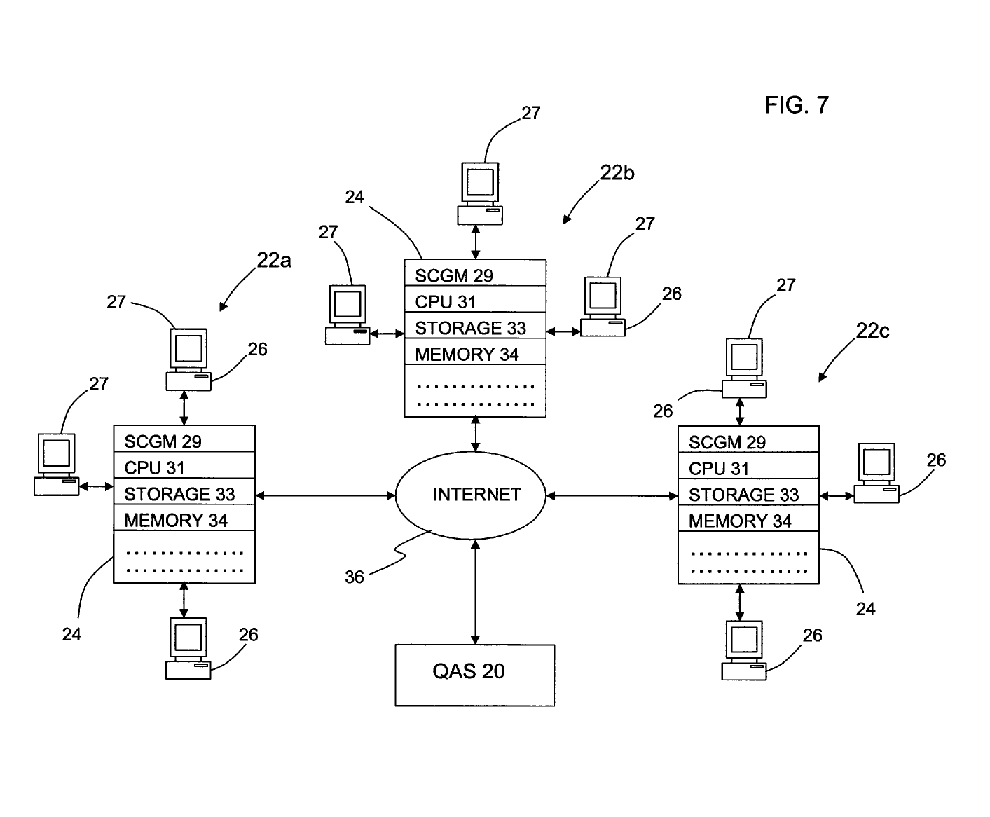

FIG. 2A illustrates an exemplary set-up process 10 for generating a set of validation rules 12 for analyzing data in a healthcare admissions system. Referring also to FIG. 7, the rules 12 may be applied to analyze the admissions data with an exemplary QA system (QAS) 20. The process 10 and the analysis of data may be part of a collaborative effort between a Quality Assurance Provider (QAP) and a Health Care Provider (HCP) such as a hospital. The QAS 20 can interface through an internet-based network system 36 to communicate with multiple HCP data systems 22 (22a, 22b, 22c) which, in the described examples, are admissions data systems each composed of a server 24 and multiple registrar terminals 26, including monitors 27, connected to the server 24. The servers 24 include the Script Code Generator Module 29 which can display user interface screens 28 of the rules editor 30 at one or more of the monitors 2, and numerous conventional components including a CPU 31, storage media 33 and memory 34 as shown in detail for HCP data system 22a. Each HCP data system may be associated with an independent hospital system. More generally, the concepts disclosed are applicable to a broad array of separate healthcare provider data systems.

FIG. 7 illustrates one of several possible configurations of the QAS 20 and multiple server-based HCP data systems 22. The process 10 is performed during an initial setup phase in which the rules 12 are identified or created, and data fields are identified such that data on which the rules may operate is identified for export to the QAS 20. A rules engine 30 incorporates the rules 12 for application to specified data ported into the system 20 to identify errors. During the initial setup process, the QAP and the HCP establish extract field specifications 14 which define a subset of data fields contained in the HCP system 22, e.g., the patient admission records. Selection of data fields in this specification may be based on a determination of which fields are vulnerable to error or omission. For hospital admissions data, the errors or omissions may be of the type which are known to result in rejection of insurance claims.

The data defined in the extract field specifications 14 may be imported to the QA system 20 and used in conjunction with a rules engine 30 in the QAS 20. The rules engine 30 is specific to each HCP data system 22 and designed to examine specific data strings extracted from the HCP data system. The extracted data strings contain information which has been input to the admissions data fields of the HCP data systems through, for example, the registrar terminals 26 by HCP staff. Specifically, the rules engine 30 is designed to evaluate each of multiple data strings relative to a set of pre-determined validation rules 12. The rules are provided as code to a data processor for execution in the QAS 20.

The validation rules 12 can be generated with the assistance of a series of Rules Editor screens. In the illustrated examples, the rules can be constructed to validate strings of data extracted from specified fields populated during a hospital admissions registration process.

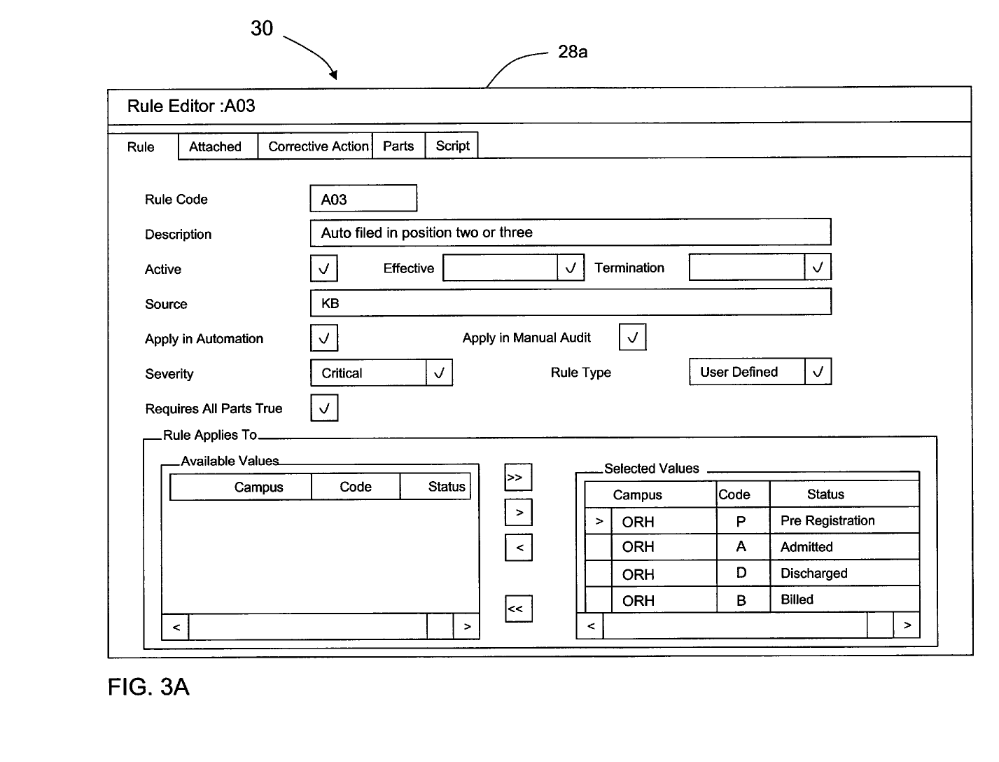

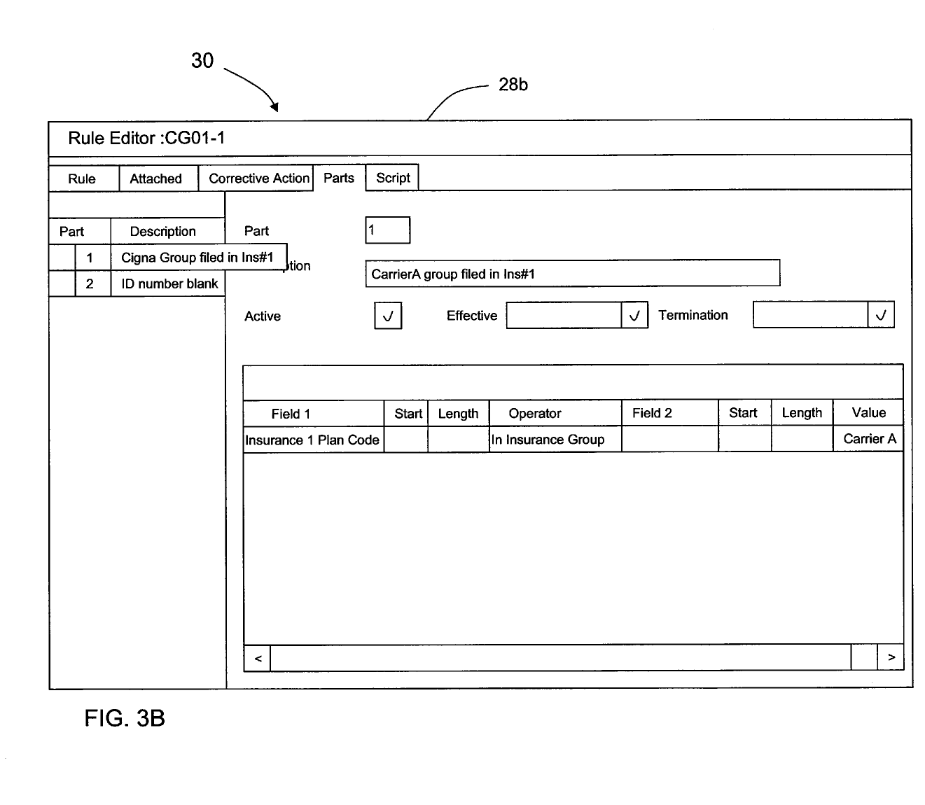

The extract field specification 14 and the files of extracted data may include names associated with the data fields in human readable form, e.g., for display to the HCP staff in user interface screens of a Rules Editor 30. See, for example, the screens 27 and 28 illustrated in FIGS. 3A and 3B. The specification 14 may also define the position of the data string associated with a field name in the extract file as well as the data type of the field. All file input to the system can be in an ASCII text format. In the embodiments described herein, the fields are comma delimited and enclosed in quotes. Records are delimited with a combination carriage return and line feed character sequences. FIG. 2B illustrates an exemplary portion 14a of an extract file specification, listing five data records 15 (e.g., 15ᵢ, where i=1-5), with each record having three fields. In discussing data strings such as the records shown in the specification 14a, fields are referenced herein as being in positions such as positions one, two, three . . . etc. with the position one being the left-most position in the record sequence and the highest numbered position being the right-most position in the sequence.

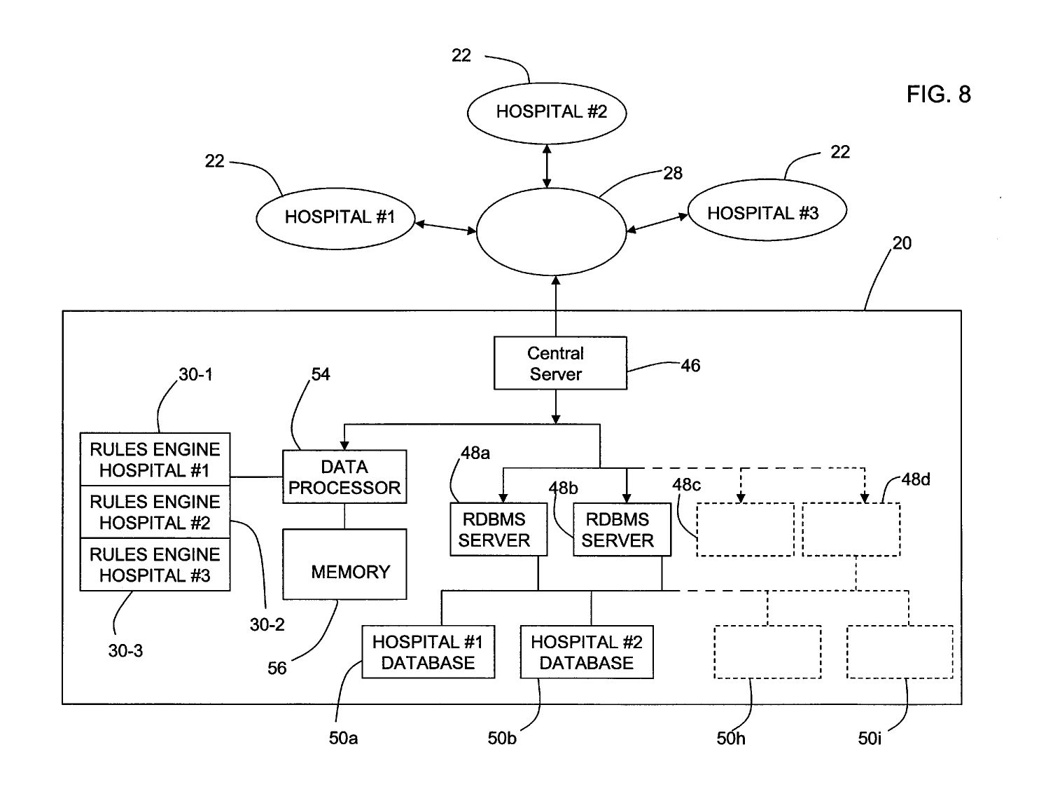

In the illustrated system, the HCP System 22 may include a a script code generator module (SCGM) 29 housed in the server 24 (e.g., created by the QAP). The script code generator module 29 may be created in Visual C# available from Microsoft Corporation. The module 29 automatically codes the rules 12, which may be user-defined, e.g., created by staff of the HCP. Initially, the HCP staff may create the rules 12 in ASCII text format via screen interfaces as described herein. The script codes are generated by the module 29, and the resulting code can be ported to the QAS 20 over the network 29 for incorporation in a rules engine data base, such as one of the data bases 30-1, 30-2 or 30-3 shown in FIG. 8. Each database may contain code specific to the HCP's customized rules engine 30 as well as other data needed for the QA System 20 to check strings of data against the rules 12. With the HCP able to directly modify or supplement the rules 12 in its customized rules engine 30, the QAS 20 can run the latest update to the rules engine every time the HCP sends a rules engine update with a patient data file to the QA for error checking. Thus, rule generation and updating of the rules engine can be entirely under the control of the HCP. Alternately, script codes may be generated by staff of the QAP in the QAS 20. Initially, the rules may be a pre-existing set of code input directly to the rules engine by processes on the QAS, or may be customized from such a set by staff of the QAP or the HCP.

Thus the HCP may begin using the system 20 with pre-defined rules but may, at any time, compose validation rules specific to its needs with the script code generator. Alternate validation rules can be written to verify whether certain data fields in the patient records of an HCP data system 22 contain complete and correct information. To this end, insurance information and patient type information can be grouped for operation of rules thereon to determine whether an account falls in a pre-defined grouping. In creating a validation rule the HCP may assign it a unique rule code and add a text description in the Rule Definition screen.

FIG. 3A illustrates a ‘Rule Definition’ user interface screen 28a of a Rules Editor 32, illustrating an exemplary rule 12 assigned a rule code number “A03” and a rule description “Auto filed in position two or three.” In this example, the rule description indicates that the rule 12 is designed to determine whether the word “auto” is present in the second field (position 15₂) or in the third field (position 15₃) of a data record. Other information for input to the Rule Definition screen includes the effective date (Effective) of the rule (i.e., when it is first used in daily processing) and the termination date of the rule (i.e., when it is no longer applied), severity, e.g., critical or non-critical rules (affects scores), and rule type, e.g., user defined. Rules are applied with parts and associated subparts as illustrated below. Each ‘Rule Definition’ screen includes a check box for “Requires All Parts True” which imposes a logical AND process in applying the outcomes of parts. If the box is checked then all parts must be true for an error to exist in the rule. Each part may include subparts which can comprise a designated field and an operator which determines whether there is an inclusion of a specified value (e.g., a word or abbreviation such as “auto” or “mvc”) in the data string of the designated field. Examples follow.

A validation rule can be made up of one or more parts which each may contain one or more sub-parts. The client can create customized rules by defining the various parts of the rule, e.g., by creating a rule part and giving it a description. In the examples provided, each part and it's corresponding subparts is a test or truth statement providing an output which can be combined with other outputs in a string of logic operations. The HCP may define the sub-parts in conjunction with identification of fields for the extract specification thereby defining data strings on which to perform the test. The extract specification may be modified as needed to provide needed data strings for customized rule definition. Each sub-part may include a validation operator for determining the compliance of a data string in a selected field with a desired criterion. Given a list of validation operators the HCP may, without direct involvement of the QAP, develop a series of customized rules 12 to test files of extracted data on a routine, e.g., daily, basis. Each file of extracted data can be organized according to a sequence of fields in each record to enable operation of one or more rules on an individual strings or records of data, or groups or classes of data. The extract field specification can be selected or changed by the HCP using a drop-down menu. The operator for each rule part can also be selected from a drop-down menu.

In an example embodiment the rules editor 32 allows the HCP to specify that all tests in a rule must be true (logical AND), or that at least one test applied to one subpart must be true (logical OR), in order for operation of the rule to result in a determination that data contains an error. Other well-known Boolean tests may be employed. When a rule 12 is based on a logical OR, only one or more sub-parts must be found true in order for operation on a part to be found true. The client may also apply a given validation rule to a grouping such as an insurance plan grouping or a particular campus or set of campuses. The term campus as used herein may refer to one of several facilities of under the management or control of one HCP. Different campuses may provide similar or identical services, but the set of campuses may be so varied as to include specialized facilities such as a day surgery center, a mental health facility or a cancer center. In other contexts, such as when the healthcare provider is a physician group medical practice, the campuses may reflect certain specializations that may be colocated or physically separate and having different database servers. As another example, group psychiatric and psychology practices may define separate “campuses” or types of services which may not be physically separate, but which relate to different insurance groups or different types of treatment or insurance coverage, e.g., one for medical coverage and one or more others for provision of various types of professional counseling services.

When the validation rule is applied to a grouping such as a group of campuses or a grouping of claim types, the QAS can apply the rules engine to only check account records that fall in the defined grouping for errors. Text, describing corrective action to be taken when an error or omission is found, may be included in a comment section associated with the validation rule. This can assure that admissions registration representatives will receive guidance on how to correct problems. In FIG. 3B, a ‘Parts Definition’ screen 28b for the exemplary rule “A03—Auto filed in position two or three” has two parts. For purposes of illustration throughout the figures, the term “Carrier” refers to a named insurance carrier. A first test part “Part 1—“Carrier” group filed in Ins #1” and a second test part “Part 2—ID number blank or incomplete” illustrates components of “Part 1—“Carrier” group filed in Ins #1”. The “Part 1—“Carrier” group filed in Ins #1” comprises three sub-parts: “Field 1—Insurance 1 Plan Code”, “Operator—In Insurance Group”, and “Value—“Carrier””

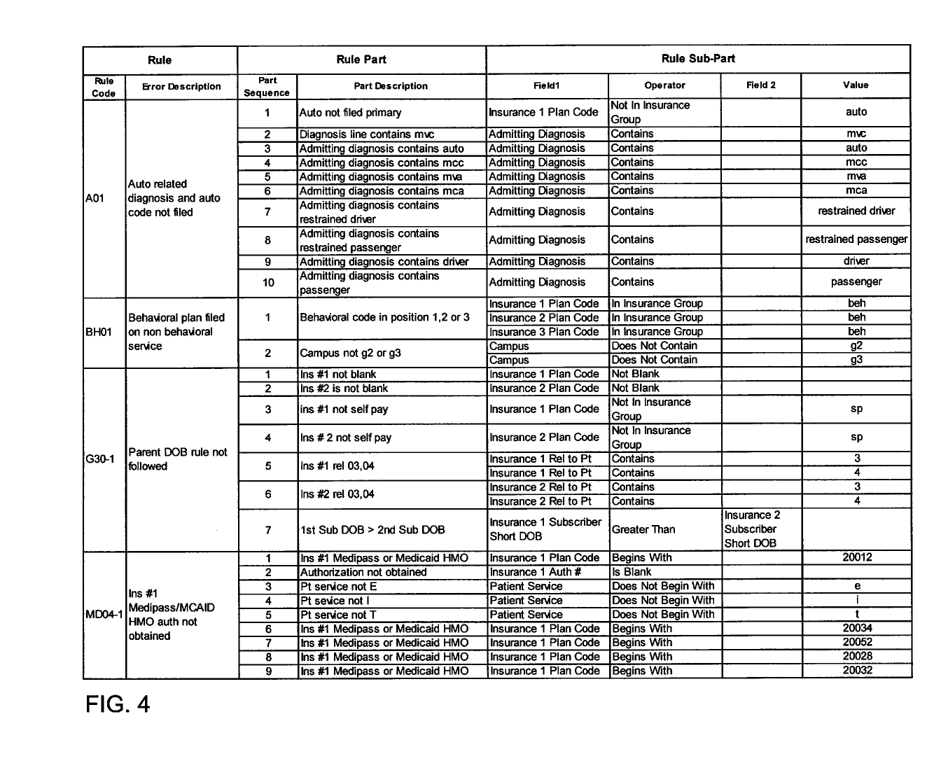

In FIG. 4, components of four exemplary validation rules are illustrated:
“A01—Auto related diagnosis and auto code not filed”,
“BH01—Behavioral plan filed on non behavioral service”,
“G30-1—Parent DOB (Date of Birth) rule not followed”, and
“MD04-1—Ins#1 Medipass/MCAID HMP (Medipass, MCAID HMP) auto not obtained”.

The rule “A01—Auto related diagnosis and auto code not filed” is a rule to check whether the auto insurance plan is listed as a secondary or tertiary insurance plan. To accomplish this the rule checks if the patient came to the hospital as the result of an automotive accident, and also checks to see if a vehicle insurance carrier was filed as the primary insurance carrier. The rule A01 comprises ten parts:
“Part 1—Auto not filed primary”

“Part 2—Admitting diagnosis line contains “mvc” (motor vehicle collision)
“Part 3—Admitting diagnosis contains “auto”
“Part 4—Admitting diagnosis contains mcc” (motor cycle collision)
“Part 5—Admitting diagnosis contains “mva” (motor vehicle accident)
“Part 6—Admitting diagnosis contains “mca”
“Part 7—Admitting diagnosis contains “restrained driver”
“Part 8—Admitting diagnosis contains “restrained passenger”
“Part 9—Admitting diagnosis contains “driver”
“Part 10—Admitting diagnosis contains passenger”

Each part may include a subpart which can comprise a designated field and an operator (e.g., contains) which checks for a specified value (e.g., “auto” or “mvc”) in the data string of the designated field.

The “Part 1—Auto not filed primary” includes a sub-part that comprises:
“Field 1—Insurance 1 Plan Code”, “Operator—Not Insurance Group”, and
“Value—auto”.

### The ““Part 2—Admitting diagnosis line contains mvc” includes a sub-part that comprises

“Field 1—Admitting Diagnosis”, “Operator—Contains”, and
“Value—mvc”.

### The ““Part 3—Admitting diagnosis line contains auto” includes a sub-part that comprises

“Field 1—Admitting Diagnosis”, “Operator—Contains”, and
“Value—auto”.

### The ““Part 4—Admitting diagnosis line contains mcc” includes a sub-part that comprises

“Field 1—Admitting Diagnosis”, “Operator—Contains”, and “Value—mcc”.

### The ““Part 5—Admitting diagnosis line contains mva” includes a sub-part that comprises

“Field 1—Admitting Diagnosis”, “Operator—Contains”, and “Value—mva”. The

### ““Part 6—Admitting diagnosis line contains mca” includes a sub-part that comprises

“Field 1—Admitting Diagnosis”, “Operator—Contains”, and
“Value—mca”.

### The ““Part 7—Admitting diagnosis line contains restrained driver” includes a sub-part that comprises

“Field 1—Admitting Diagnosis”, “Operator—Contains”, and
“Value—restrained driver”.

### The ““Part 8—Admitting diagnosis line contains restrained passenger” includes a sub-part that comprises

“Field 1—Admitting Diagnosis”,
“Operator—Contains”, and
“Value—restrained passenger”.

### The ““Part 9—Admitting diagnosis line contains driver” includes a sub-part that comprises

“Field 1—Admitting Diagnosis”,
“Operator—Contains”, and
“Value—driver”.

### The ““Part 10—Admitting diagnosis line contains passenger” includes a sub-part that comprises

“Field 1—Admitting Diagnosis”,
“Operator—Contains”, and
“Value—passenger”.

The rule “BH01—Behavioral plan filed on non behavioral service” is a rule to determine whether a behavioral insurance plan is identified as primary, secondary, or tertiary insurance when the service provided is not covered under the designated plan. The rule also determines whether the account was registered in an area other than a Behavioral area of the hospital. That is, the rule can be used to find accounts that are not in the BEH campus but which are nonetheless using a behavioral Insurance code.

The rule BH01 comprises two parts:

### “Part 1—Behavioral code in position 1, 2, or 3” and

“Part 2—Campus not g2 or g3” (wherein g2 and g3 are specified behavioral health facilities in the hospital system). If the check box in the ‘Rule Definition’ screen for “Requires All Parts True” is checked then all parts must be true for an error to exist in the rule. Each part may include a subpart which can comprise a designated field and an operator (e.g., does not contain) which checks for a specified value (e.g., campus “g2”) in the data string of the designated field.
The “Part 1—Behavioral code in position 1, 2, or 3” comprises three sub-parts, (i) a first sub-part including:
“Field 1—Insurance 1 Plan Code”,
“Operator—In Insurance Group”, and
“Value—beh” (beh—behavioral);
   (ii) a second sub-part including “Field 1—Insurance 2 Plan Code “Operator—In Insurance Group”, and “Value—beh”; and
   (iii) a third sub-part including “Field 1—Insurance 3 Plan Code”, “Operator—In Insurance Group”, and “Value—beh”.

### If any of the sub-parts is true then the Part is true.

### The “Part 2—Campus not g2 or g3” comprises two sub-parts:

(i) a first sub-part including:
“Field 1—Campus”,
“Operator—Does Not Contain”, and
“Value—g2”; and
   (ii) a second sub-part including:
“Field 1—Campus”,
“Operator—Does Not Contain”, and
“Value—g3”.

### If either of the sub-parts is true then the Part is true.

The rule “G30-1—Parent DOB rule not followed” checks for parent date of birth information first by determining whether insurance information was input to the INS#1 and INS#2 fields. Next it rules out self-pay and then checks the relationship of the insured to the patient to see that the insured is a mother or father. The last check is to confirm that the parent whose birthday falls first in the calendar year is listed as the primary insurance. The illustrated implementation of this rule requires seven parts:
“Part 1—Ins #1 not blank”
“Part 2—Ins #2 not blank”
“Part 3—Ins #1 not self pay”
“Part 4—Ins #2 not self pay”
“Part 5—Ins #1 rel 03,04”
“Part 6—Ins #2 rel 03,04” and
“Part 7—1^{st} Sub DOB>2^{nd} Sub DOB”.

### With the check box in the ‘Rule Definition’ screen for “Requires All Parts True” being checked, all parts must be true for an error to exist in the rule.

The “Part 1—Ins #1 not blank” includes a sub-part that comprises “Field 1—Insurance 1 Plan Code”, “Operator—Not Blank”. The “Part 2—Ins #2 not blank” includes a sub-part that comprises “Field 1—Insurance 2 Plan Code”, “Operator—Not Blank”. The “Part 3—Ins #1 not self pay” includes a sub-part that comprises “Field 1—Insurance #1 not self pay”, “Operator—Not In Insurance group”, and “Value—sp” (i.e., self pay). The “Part 4—Ins #2 not self pay” includes a sub-part that comprises “Field 1—Insurance #2 not self pay”, “Operator—Not In Insurance group”, and “Value—sp”. The

### “Part 5—Ins #1 rel 03,04” includes two sub-parts:

(i) a first sup-part that comprises:
“Field 1—Insurance 1 Rel to Pt”
“Operator—Contains”, and
“Value—3”
(ii) a second sub-part that comprises
“Field 1—Insurance 1 Rel to Pt”
“Operator—Contains” and
“Value—4”.

### The “Part 6—Ins #2 rel 03,04” includes two sub-parts:

(i) a first sup-part that comprises:
“Field 1—Insurance 2 Rel to Pt”
“Operator—Contains” and
“Value—3”.
(ii) a second sub-part that comprises:
“Field 1—Insurance 2 Rel to Pt”
“Operator—Contains” and
“Value—4”.
   The “Part 7—1^{st} Sub DOB>2^{nd} Sub DOB” includes a sub-part that comprises:
“Field 1—Insurance 1 Subscriber Short DOB”
“Operator—Greater Than” and
“Field 2—Insurance 2 Subscriber Short DOB”.

The rule “MD04-1—Ins#1 Medipass/MCAID HMP auto not obtained” checks for Medicaid HMO authorization by determining whether the insurance plan code begins with 20012, 20034, 20052, 20028, or 20032 and patient service is not T (Observation) I (Inpatient), or E (Emergency), but the authorization field has been left blank. The rule MD04-1 comprises nine parts:
“Part 1—Ins #1 Medipass or Medicaid HMO”
“Part 2—Authorization not obtained”
“Part 3—Pt service not E”
“Part 4—Pt service not I”
“Part 5—Pt service not T”
“Part 6—Ins #1 Medipass or Medicaid HMO
“Part 7—Ins #1 Medipass or Medicaid HMO”
“Part 8—Ins #1 Medipass or Medicaid HMO “
“Part 9—Ins #1 Medipass or Medicaid HMO”.

With the check box in the ‘Rule Definition’ screen for “Requires All Parts True” being checked, all parts must be true for an error to exist in the rule.

The “Part 1—Ins #1 Medipass or Medicaid HMO” includes a sub-part that comprises:
“Field 1—Insurance 1 Plan Code”
“Operator—Begins With” and
“Value—20012”.
   The ““Part 2—Authorization not obtained” includes a sub-part that comprises:
“Field 1—Insurance 1 Auth #”
“Operator—Is Blank” and
“Value—”.
   The ““Part 3—Pt service not E” includes a sub-part that comprises:
“Field 1—Patient Service”
“Operator—Does Not Begin With” and
“Value—e”.
   The “Part 4—Pt service not I” includes a sub-part that comprises:
“Field 1—Patient Service”
“Operator—Does Not Begin With” and
“Value—i”.
   The ““Part 5—Pt service not T” includes a sub-part that comprises:
“Field 1—Patient Service”
“Operator—Does Not Begin With” and
“Value—t”.
   The ““Part 6—Ins #1 Medipass or Medicaid HMO” includes a sub-part that comprises:
“Field 1—Insurance 2 Plan Code “Operator—Begins With” and
“Value—20034”.
   The ““Part 7—Ins #1 Medipass or Medicaid HMO” includes a sub-part that comprises:
“Field 1—Insurance 2 Plan Code “Operator—Begins With” and
“Value—20052”.
   The ““Part 8—Ins #1 Medipass or Medicaid HMO” includes a sub-part that comprises:
“Field 1—Insurance 2 Plan Code “Operator—Begins With” and
“Value—20028”.
   The ““Part 9—Ins #1 Medipass or Medicaid HMO” includes a sub-part that comprises:
“Field 1—Insurance 2 Plan Code “Operator—Begins With” and
“Value—20032”.

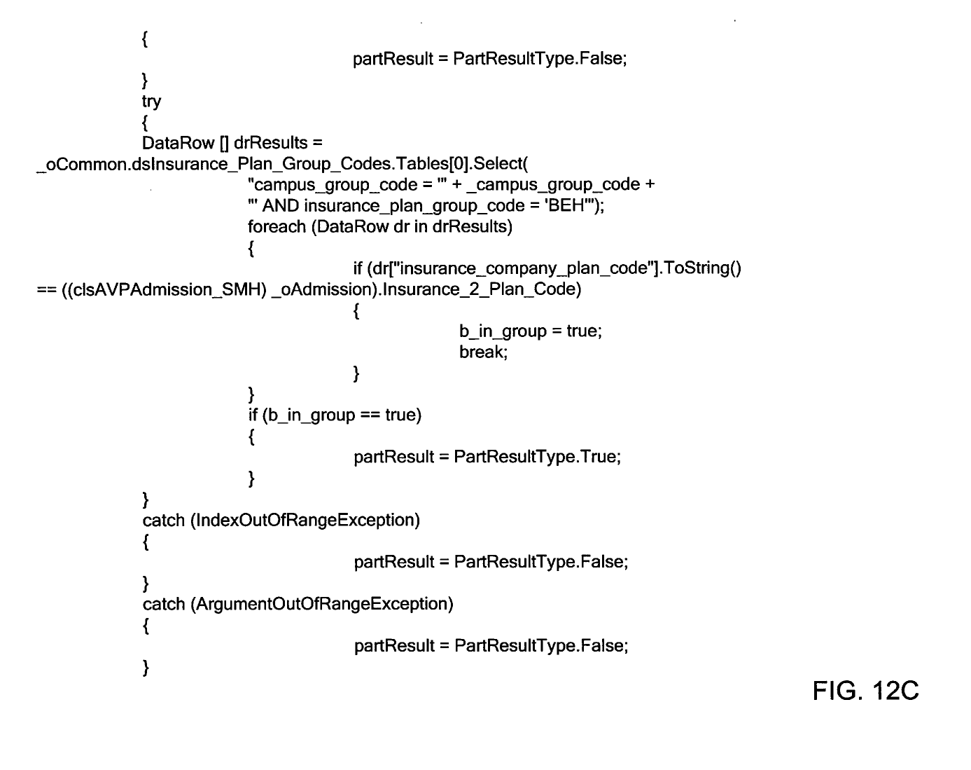

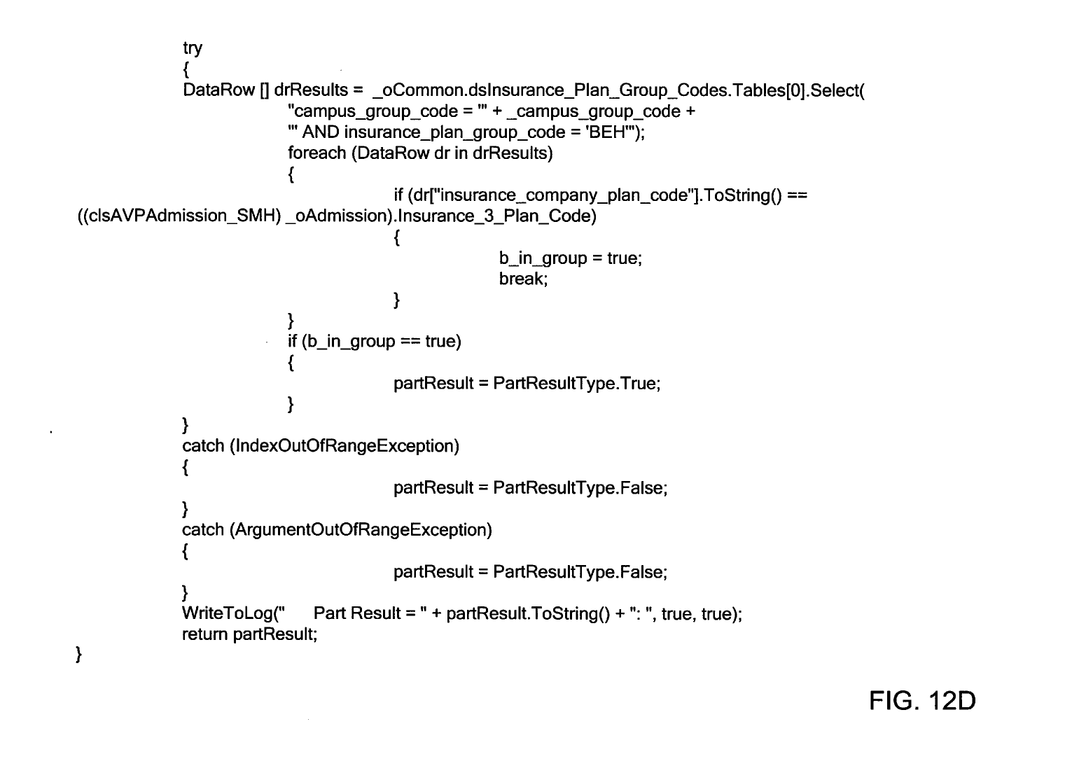

FIGS. 12A and 12B illustrate exemplary script code for the rule “BH01—Behavioral plan filed on non behavioral service”.

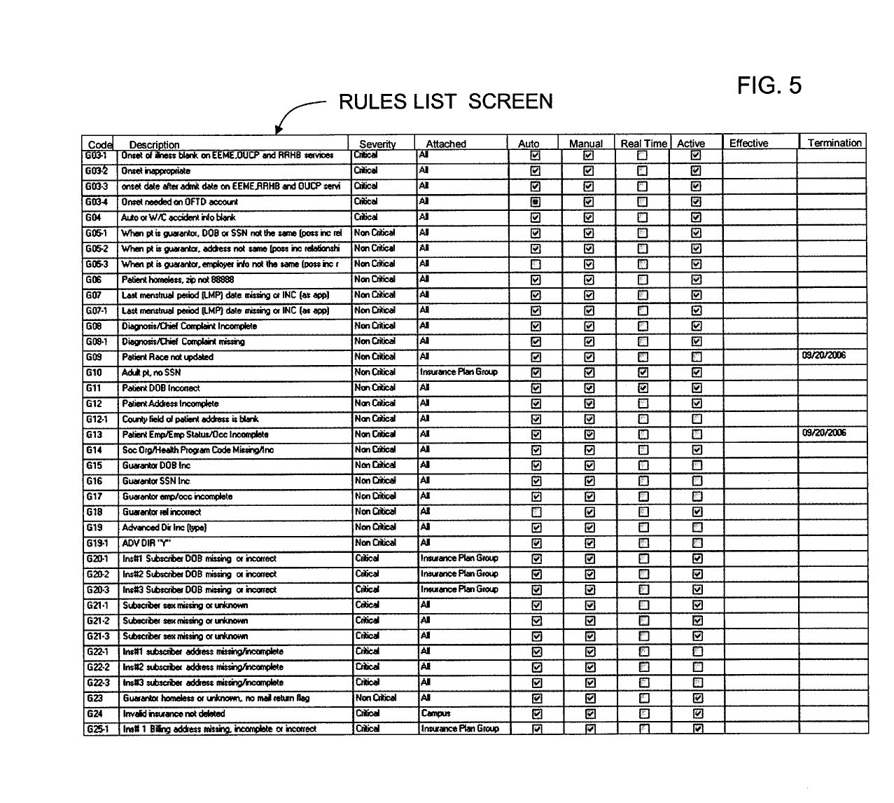

FIG. 5 is a partial list of rules 12 of the QAS 20 describing the severity, attached group, method of validation (Auto, manual), Effective (Effective Date for initiation), and Termination (Termination Date) of each rule. As used in the list, EEME refers to Emergency Medical Service; OUCP refers to Outpatient Medical Service); OFTD refers to Outpatient Follow-Up for Treatment (Discharged account); W/C refers to Workers Compensation Insurance, RRHB refers to Rehab Medical Service; DOB refers to Date of Birth; and SSN refers to Social Security Number.

Once the rules are established, the QAS can perform analysis of data entries. The data entries associated with the extracted fields can be periodically exported (e.g., in a batch mode) from the healthcare admissions system to the QAS to populate look-up tables. Alternately, with a continuous connection between the healthcare admissions system and the QAS, the rules can be applied on a continual or on a real-time basis.

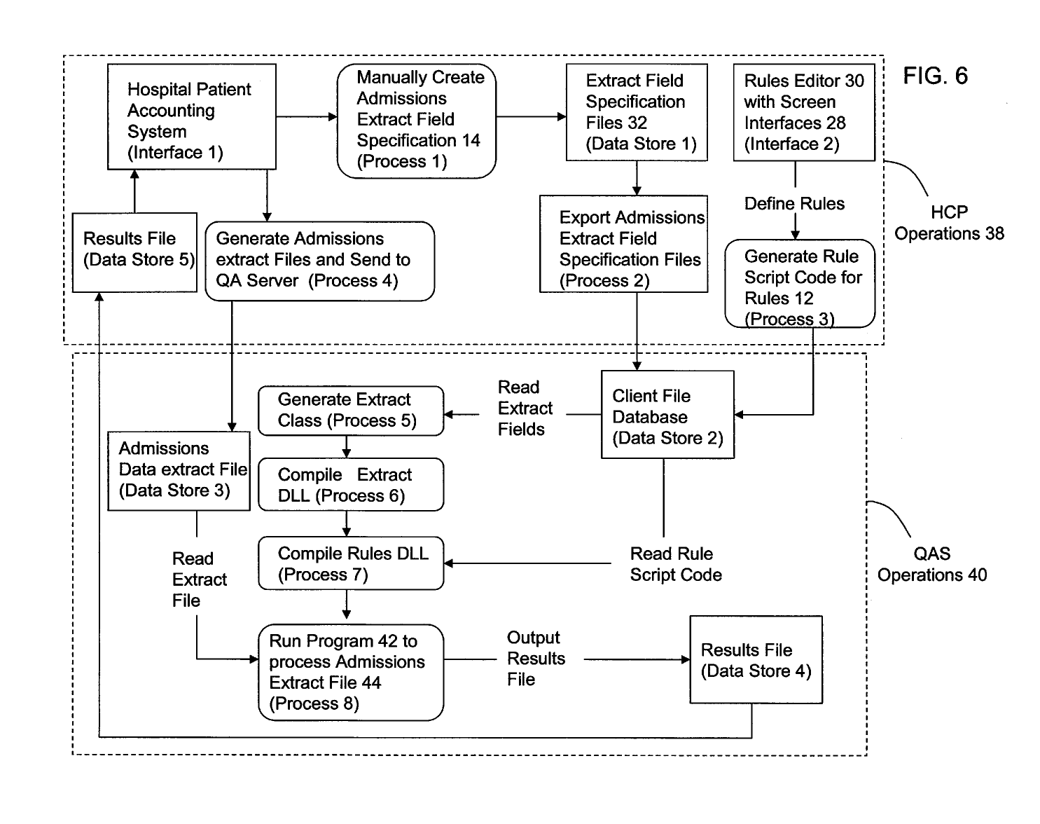

FIG. 6 provides an overview of operations for the QAS 20 applied to patient admissions data. In this example programming functions are part of the HCP operations 38 performed on the servers 24 of the HCP data systems 22. A set of admissions extract field specifications 14 are generated as described for the process 10 and files of extracted data are initially stored on the HCP's server 24. (Data Store 1) OK. A set of validation rules are generated by the client (Process 3) with the QA user interface (Interface 2) as described with respect to FIG. 2A. The validation rules are automatically converted into script code (Process 3) with insertion of information about the fields that are being checked into a template associated with each selected operator. The extract field specification files are then exported to the QAS database (Process 2). When a healthcare service is provided at a healthcare facility, the admissions data files containing the extract field data, herein referred as admissions extract files, are generated by a registrar during pre-registration of a patient (Interface 1). A HCP systems operator periodically, e.g., once per day, sends the admissions data in the form of General Admissions Extract Files to the QAS 20 (Process 4).

Operations 40 in the QAS include receiving the rules 12 provided in script code which are saved with the other rule information in a portion of the client database, e.g., 30-1, referred to as Data Store 2 in FIG. 6, for retrieval each time the rules engine 30 is compiled. Upon receipt of the admissions data file, the admissions extract files are also stored in a portion of the client database, referred to as Data Store 3 in FIG. 6. Code representing the admissions extract fields is generated in the form of a class (Process 5) and compiled at run time into a binary Dynamically Linked Libraries (DLL) (Process 6) for use in a data validation processing program 42. The program 42 can access patient data present in an admissions data extract file 44 through a series of function calls to Data Store 3 as defined by an interface specification that is used for all clients. The processing program 42 also retrieves the previously saved script code and compiles it into a binary DLL (Process 7) to apply the individual validation rules 12. The program 42 applies each validation rule 12 to check each patient account in the admissions data extract file 44 and returns with a PASS or FAIL value each time a patient account is checked by a rule (Process 8). Result files are stored in a database in the QAS 20 referred to as Data Store 4 and are later ported back to the client's database and stored (Data Store 5) on the HCP server 24. Each FAIL can be routed to a specific one of the client's individual registrars that keyed in the associated patient account information.

FIG. 7 illustrates, generally, a health care admissions data quality assurance system 70 comprising the QAS 20 and a plurality of client database servers 24 each connected to the QAS 20 over an internet connection. Multiple registrar computer terminals 26 are shown connected to each client database server 24. The registrars (operators) from each client system can individually submit admissions data extract files and receive validation reports specific to their input activities or, as noted above, this can be done for all patient data by assembling the extract files 44 once on a periodic basis.

With reference again to FIG. 8, the QAS 20 is shown to include a central server 46 and a plurality of Relational Database Management Servers (RDBMSs) 48 (e.g., 48a, 48b . . . 48h, 48i . . . ) connected to a plurality of databases 50 (e.g., 50a, 50b . . . 50h, 50i, . . . ), and a data processor 54 connected to memory 56 with which any of a plurality of rules engines 30, e.g., 30-1, 30-2 and 30-3, are compiled at run time of the data validation program 42. Each rules engine 30, containing customized rules, is dedicated to a corresponding client, e.g., Hospital #1, Hospital #2 and Hospital #3. The processor 54 and memory 56 may be within the central server 46.

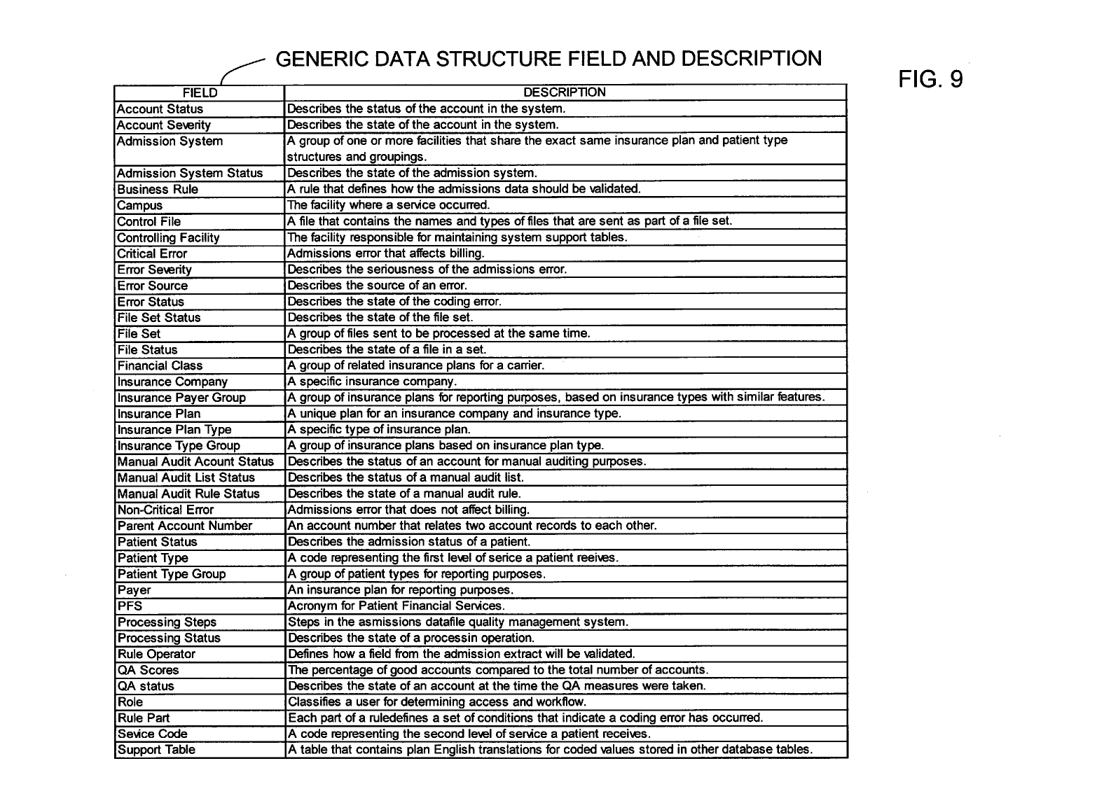

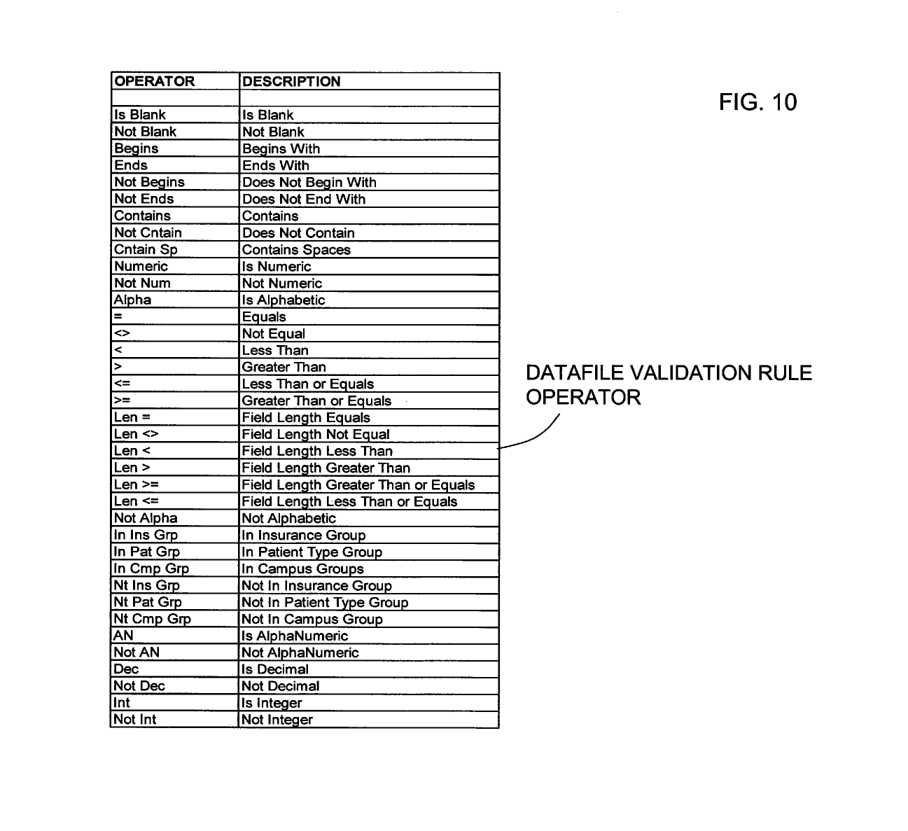

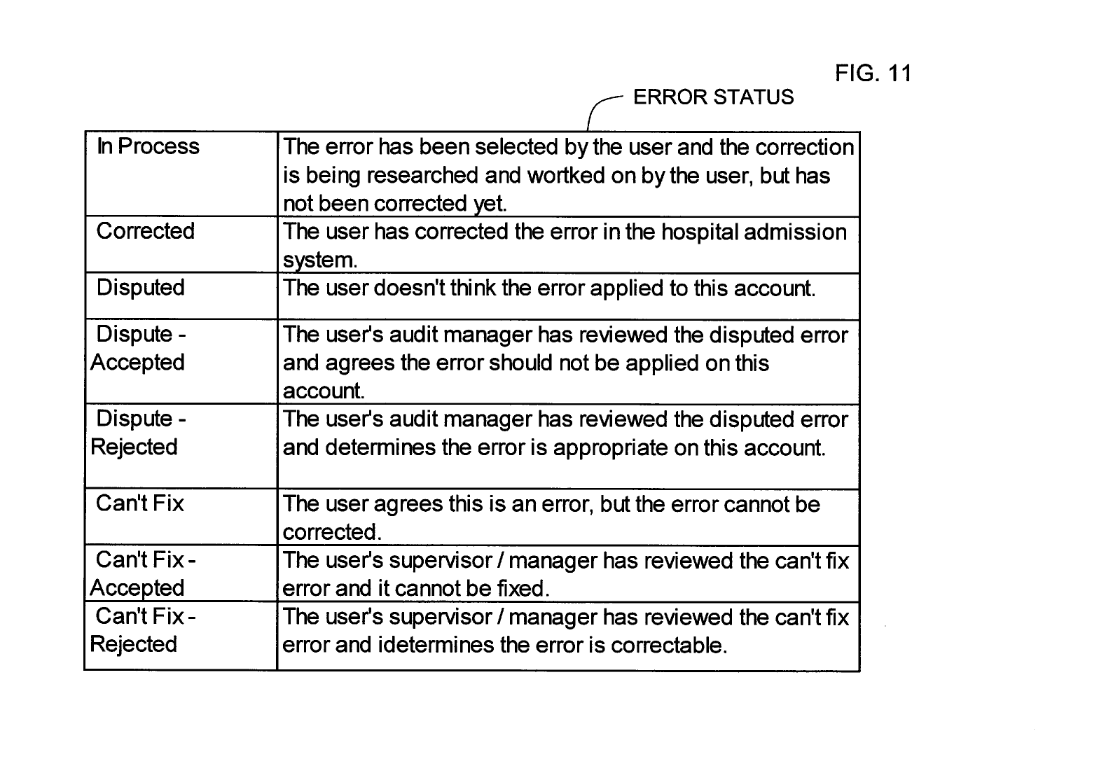

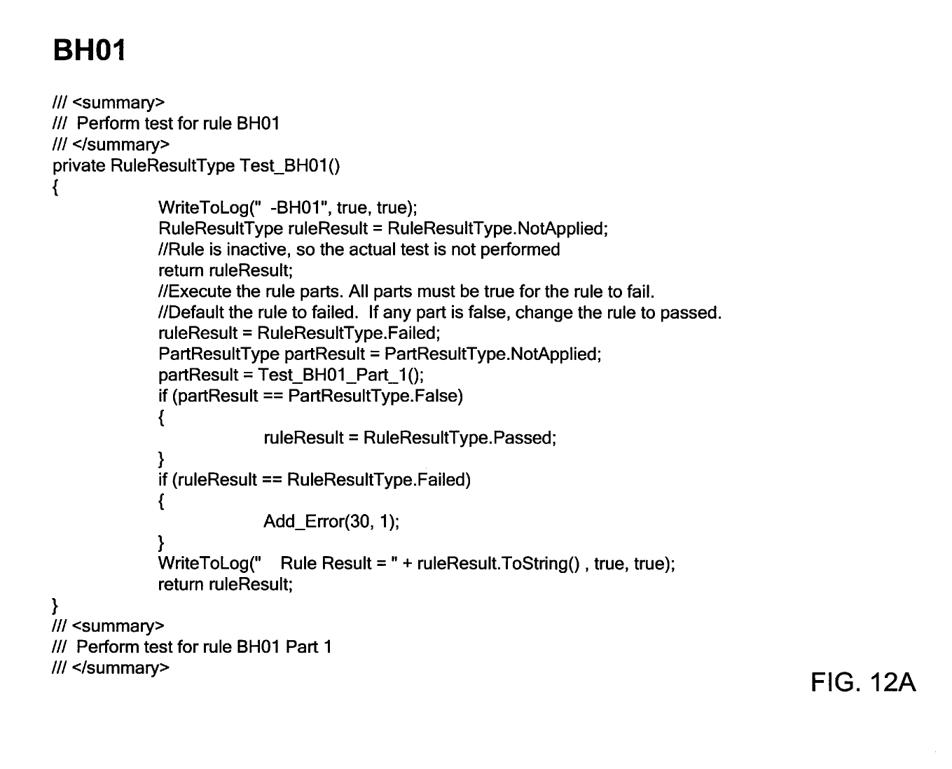

An admissions data entry validation process according to one embodiment of the invention begins with generating an admissions data extract file 44 for all active correct patient admissions data, which may be temporarily stored on the HCP server 24. In different embodiments smaller extract files of admissions data may be generated by or for individual registrars. Other arrangements are also contemplated. The resulting extract file 44 may be sent via the Internet, e.g., in a batch mode, to the QAS central server 46 for validation. The data validation program 42 applies the appropriate Rules Engine 30 against the extract file 44 to identify errors (or FAILS) in the admissions data which are then presented in an error report for review by one or more registrars for correction. The registrar may have some errors that are not fixable with the instructions provided. The registrar may then notify HCP management of such ‘Can't Fix Errors’. FIG. 9 is an exemplary list of structure field names which may be used in the system 70. For example, the field name ‘Account Status’ describes the state of an account, e.g., ‘Open’, ‘In Process’, ‘Disputed’, ‘Can't Fix’, ‘Assignment Error’, ‘Completed’, and ‘Closed’. FIG. 10 is a sample list of validation rule operator names and descriptions. For example, the rule operator ‘Is Blank’ tests whether the field, to which a particular rule is applied, is null or contains all blanks.

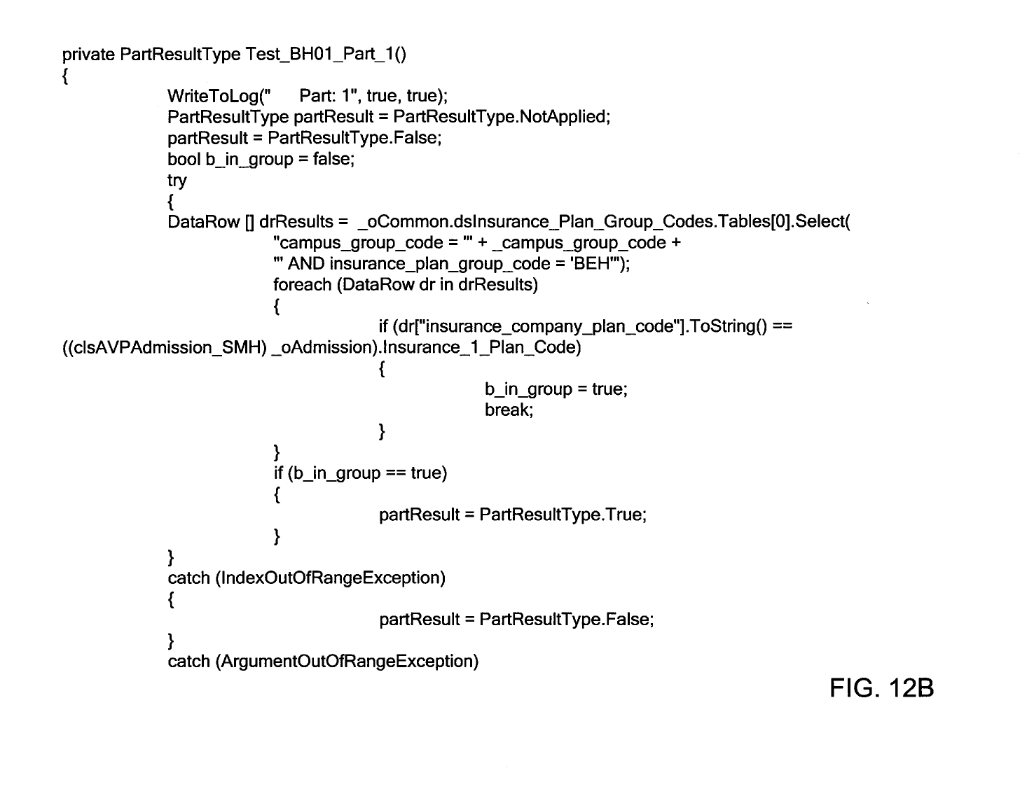

FIG. 11 is a list of error status names and descriptions. For example, the error status ‘In Process’ means that the error has been selected by the user for correction, but has not been corrected yet.

The illustrated dynamic rules engine 30 reviews healthcare admissions data records for errors. The review may be based on client-defined validation rules that can be modified on an as-needed basis, e.g., directly by the HCP and without involvement of the QAP, such changes being readily accommodated by the QAS which compiles the code at run time. Conventionally, rules engines have run a pre-compiled software program, i.e., typically the binary executable file is stored in form for immediate execution upon loading into memory. A feature of the data validation processing program 42 is a dynamic rules engine 30 which, as described herein, is capable of being revised or supplemented by HCP staff to provide the flexibility of running modified rules at the discretion of HCP management. This capability can be critically important to the HCP to achieve error-free healthcare admissions data files because, for example, of continuously changing insurance information and criteria, and the ability to reduce errors by continually managing the claims process from the patient admissions stage through claim approval. Further, it is common for health insurance plans to be revised on a yearly basis and patients may change plans at any time with little notice to the provider. Compiling the code into one or more binary DLLs at run time enables immediate incorporation of new rules to enable an HCP to address new issues arising in health coverage as these may affect the provision of admissions data and the efficiency of the claims process. Generally, this approach can enable an HCP to quickly address new sources of errors resulting from changes in the claims process. According to some embodiments, data retrieval from HCP and QAP storage media is not required during execution of the processing program 42. For example, in the disclosed system, sets of field extract information needed to run individual rules are loaded into memory when the code is compiled. Thus there is no need to access storage locations while the program is running.

Summarily, a data processing engine has been presented which allows custom rules to be created in order to identify errors in the content of hospital admission record data files. The data files are input to the QAS 20 and stored in a relational database. A user interface allows operators to define or modify complex validation rules involving data fields using the non-programming language of the HCP staff, e.g., English text. A programmatic representation of a rule 12 is created from the non-programming language text and the corresponding source code is stored in the relational database. New files containing revised rules may be received periodically and stored, e.g., written over the prior files. At run time, the stored rules definition code is compiled into binary DLLs which are read into memory. Error results (e.g., PASSES and FAILS) are output by the processing program into result files.

Also in accord with several embodiments of the invention, a set of selected data fields, e.g., field headings, in the patient data admissions files is entered into an extract file specification to provide the HCP a set of data fields with which to create the rules 12. The fields may include, for example, insurance plan, insurance group number, patient type, and diagnosis. The fields may be manually extracted and input to the system via a spreadsheet program so they can also be used to map associated data entries to table look-up locations. The QAS 20 provides the client a set of validation operators with which rules can be created to operate on the data entries associated with the selected data fields. A validation operator may be an instruction for determining the compliance of a data string in a selected field with a desired criterion. With the list of validation operators and the extract field specification files, the client can generate data file validation rules, each rule comprising a code name, a description, and one or more rule parts. Each rule part may have one or more rule sub-parts. Each rule part comprises an extract field, an operator, and a value. Each field is populated from the admissions data according to the extract field specification 14 prepared during the set-up phase using a drop-down menu. The operator field for each rule part is also selected from a drop-down menu.

Although embodiments of the invention have been illustrated and described, the invention is not so limited. Numerous modifications, variations, substitutions and equivalents will occur to those skilled in the art without departing from the spirit and scope of the present invention.

I claim:

1. A method of identifying need to modify data entries in a database containing healthcare admissions data, comprising the steps of:
providing a first computer system for performing analysis of patient data generated by a health care provider and stored in a second computer system under the control of the health care provider;
repeatedly receiving, from the second computer system into the first computer system, one or more editions of code for applying error-checking rules to at least a portion of the admissions data, the code being received at the first computer system in a first form;
also repeatedly receiving into the first computer system information present in the health care admissions data for performing analysis thereon;
each time, after receiving a set of information present in the health care admissions data, converting the most recently received edition of the code into executable code for applying the rules; and
applying the rules to evaluate the most recently received information.

2. The method of claim 1 wherein the one or more editions of code are received into the first computer system as human readable source code.

3. The method of claim 1 wherein the information is received by the first computer system in accord with an extract file specification including a first format suitable for application of the rules.

4. The method of claim 1 further including generating a data file report by the first computer system and transferring the report from the central database computer system to the second computer system thereby enabling an operator to modify entries in the healthcare admissions database.

5. The method of claim 1 wherein the information and the code and the error reports are transferred between the first system and the second system via an internet connection.

6. The method of claim 1 wherein operation of the first system is under the control of a quality assurance provider and the editions of code received from the second computer system are generated in human readable text with a user interface made available by the quality assurance provider, said interface including pre-defined drop-down listings and field text.

7. The method of claim 1, wherein the first system stores the code, and the information in human readable form.

8. The method of claim 1 wherein the code is received by the first system as source code and is then compiled for execution in coordination with execution of other code resident in the first system.

9. A data quality management system for managing healthcare admissions data, the system comprising:
a first computer system comprising at least one server and having storage media containing:
a plurality of sets of patient data each assembled by a different health care provider and useful in relation to filing of insurance claims,
a plurality of different rules engines each customized for a different health care provider and each stored in human readable code; and
a program which when run on the first computer system compiles a first of the rules engines customized for a first of the health care providers wherein rules associated with the first rules engine are applied to identify needs for modifying a set of patient data received from the first health care provider.

10. The system of claim 9 configured to receive the sets of patient data and the rules engines via the Internet.

11. The system of claim 9 configured to generate an error report, and to send the error report to a second computer system under the control of the first health care provider; and
a data communication network enabling transfer of data and error reports between the first computer system and the second computer system.

12. The system of claim 11 wherein the communication network includes the Internet.

13. The system of claim 9 wherein the first system includes a central system database server, a central system database, a central system data processor, a central system memory, and a central system router for providing connection between the central system database server and the second computer system.

14. The system of claim 13 wherein the central system database server is a relational database management server (RDBMS) for providing relational database queries.

15. A computer system including a data processor and memory and software for evaluating healthcare admissions data file quality, comprising:
a system router configured to receive multiple files each containing information extracted from healthcare provider patient data files stored in a database remote from the computer system;
one or more database servers including storage for retaining each of the patient data files distinct from the other; and
multiple versions of rules code each simultaneously stored in source code form on the one or more servers and each associated with a different provider file, characterized in that when each version is compiled and executed by the data processor, the code evaluates information from the associated provider file relative to a set of predetermined validation rules.

16. The system of claim 15 further including a reporting capability for generating an error report that identifies individual errors in the information.

17. The system of claim 15 wherein the system router provides connection between the database server and the data processor.

18. The system of claim 15 including multiple processors to enable execution of different versions of the code on different processors in order to evaluate different provider files.
